(19) United States
(12) Patent Application Publication
(10) Pub. No.: US 2023/0306310 A1
(43) Pub. Date: Sep. 28, 2023

(54) FEDERATED LEARNING ADAPTIVE TO CAPABILITIES OF CONTRIBUTING DEVICES

(71) Applicants: Miltiadis Filippou, Muenchen (DE); Leonardo Gomes Baltar, Muenchen (DE)

(72) Inventors: Miltiadis Filippou, Muenchen (DE); Leonardo Gomes Baltar, Muenchen (DE)

(21) Appl. No.: 18/325,374

(22) Filed: May 30, 2023

Related U.S. Application Data
(60) Provisional application No. 63/378,086, filed on Oct. 3, 2022.

(51) Int. Cl. G06N 20/00

(52) U.S. Cl. CPC G06N 20/00

(57) ABSTRACT

An aggregating device may be in communication with contributing devices. The aggregating device may maintain a model collection including machine learning models for performing the same type of task. The aggregating device may receive, from a contributing device, a status report including information associated with one or more resources available at the contributing device. The aggregating device may compress the model collection based on the status report and transmit the compressed model collection to the respective contributing device. The contributing device may train one or more models in the model collection using data available at the contribution device. The data used for training models may not be transmitted to the aggregating device. The aggregating device may receive, from the contributing device, information associated with an update of the one or more models. The aggregating device may update the model collection based on the information received from the contributing device.

### CROSS REFERENCE TO RELATED APPLICATION

This application claims the benefit of U.S. Provisional Patent Application No. 63/378,086, filed Oct. 3, 2022, which is incorporated by reference in its entirety.

### TECHNICAL FIELD

This disclosure relates generally to federated learning, and more specifically, federated learning adaptive to capabilities of contributing devices.

### BACKGROUND

Federated learning is also known as collaborative learning. It is a technology for collaborative, multi-device over-the-air machine learning. A system for federated learning usually includes contributing devices and an online device in communication with the contributing devices. The contributing devices can use locally available data to train a model, and the online device (e.g., an edge cloud server) can coordinate the training by the contributing devices. Training data locally available at a contributing device is usually not collected at the network node for model training purposes.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG. 1 illustrates a federated learning environment, in accordance with various embodiments.

FIG. 2 is a block diagram of an aggregating device, in accordance with various embodiments.

FIG. 3 is a block diagram of a contributing device, in accordance with various embodiments.

FIG. 4 illustrates a process of an aggregating device admitting a new contributing device, in accordance with various embodiments.

FIG. 5 is a flowchart showing a method of federated learning adaptive to capabilities of contributing devices, in accordance with various embodiments.

FIG. 6 is a block diagram of an example computing device, in accordance with various embodiments.

### DETAILED DESCRIPTION

### Overview

Model training through federated learning may be performed in an iterative approach, where, in each training cycle, the central entity (aggregator) broadcasts an overall model to the contributing devices, which, in their turn, update it based on locally available data. The updated local models are then sent back to the aggregator, which produces a new aggregated model. For instance, the central entity may generate the aggregated model by averaging the collected updated local models in each training round.

There are several technical challenges for currently available implementations of federated learning. Firstly, the federated learning scheme takes place iteratively over-the-air, thereby resulting into increased communication signaling in each training round, both in uplink (for the upload of updated local models) and in downlink (for the broadcasting of the updated aggregated machine learning model). Such radio resource occupation may become extremely intensive in the case where the models have large model parameter sets (e.g., weights and bias values for a neural network).

Additionally, the exchange of large model parameter sets during a federated learning procedure precludes that there is considerable processing, memory, storage, and energy resources available both at the aggregator side and at the contributing devices themselves during the federated learning procedure and after it for inferencing purposes. This is, however, a non-realistic assumption, especially when the contributing devices are Internet of Thing-like ones with very limited compute platform capabilities. Even for more compute and energy capable devices, availability of computing and communication resources may significantly fluctuate due to incoming workloads different from ones relating to federated learning.

An approach to achieve communication and storage-efficient federated learning is model dropout, which includes randomly dropping out a (fixed) fraction of model neurons before model transfer (e.g., for federated learning or for transfer learning purposes). Another approach is sparsity-based compression of models. For instance, neuron weights which are below a threshold number (e.g., close to zero) are not communicated to the recipient (e.g., not communicated to the aggregator). Such compression can be applied, e.g., in combination with model dropout or as standalone. Yet another approach is model parameter quantization. For example, 8-bit representations are used instead of higher-resolution ones. This approach can be possibly applied also in combination with model dropout and model sparsity-based compression (e.g., for the “surviving” model parameters).

Although these approaches, when applied, may lead to lower communication overheads and small inferencing accuracy loss, these approaches are generally applied uniformly (i.e., applying the same dropout rate or sparsity criterion and model parameter quantization scheme) across all contributing devices. This way, several per-device characteristics are overlooked, which can limit the potential of federated learning in terms of inferencing accuracy, model training time and end-to-end energy efficiency. Additionally, even when model pruning, sparsity-based compression, or model parameter quantization is applied, the amount of data needs to be transmitted over-the-air during the federated learning procedure can still be significant. Therefore, improved technologies for federated learning are needed.

Embodiments of the present disclosure may improve on at least some of the challenges and issues described above by facilitating federated learning adaptive to capabilities of contributing devices. Contributing devices may train machine learning models (also referred to as “models”) with local data, such as data generated or received by the contributing devices themselves. The training done by the contributing devices may be aggregated by an aggregating device that is in communication with the contributing devices, e.g., through a network. The aggregating device may maintain one or more model collections, each of which may include models to be used for a particular type of task, e.g., the same task or similar tasks. The aggregating device can facilitate federated learning adaptive to capabilities of the contributing devices by providing the contributing devices model collections compressed based on the capabilities of the contributing devices.

In various embodiments, the aggregating device may receive, from each respective contributing device, a capability status report including information associated with one or more resources available at the respective contributing device. The aggregating device may compress a model collection based on the status report to generate a compressed model collection and transmit the compressed model collection to the respective contributing device. The contributing device may train one or more models in the model collection using data available at the contribution device. The data used for training models may not be transmitted to the aggregating device or other contributing devices. The aggregating device may receive, from the contributing device, information associated with an update of the one or more models. The information associated with a model may include updated internal parameters of the model, a similarity score of the model (e.g., a score indicating the degree of similarity between the model and one or more other models), an error score of the model (e.g., a score indicating an error rate of the outputs of the model), or other information associated with the model.

The aggregating device may update the model collection based on the information received from the contributing device. For example, the aggregating device may add a model trained by a contributing device into the model collection. As another example, the aggregating device may generate a new model by aggregating models trained by multiple contributing devices and add the new model to the model collection. As yet another example, the aggregating device may remove a model from the model collection based on an evaluation of the model by one or more contributing devices. The aggregating device may facilitate multiple rounds of updates of the model collection. In each round, at least one model may be updated by at least one computing device, and the aggregating device may update the model collection. In some embodiments, the aggregating device may keep updating the model collection till at least model in the model collection has sufficiently good performance (e.g., the similarity score is beyond a threshold, or the error score is below a threshold) are generated. The model may be provided to the contributing devices or other devices to perform the type of task.

The present disclosure provides an approach to increase the footprint of machine learning in-network capability by offering lightweight federated learning that is adaptive to the capabilities of contributing devices, such as IoT-like devices, the compute platform of which can sometimes be limited. A larger pool of devices can be better positioned to contribute to federated learning setups without sacrificing their energy autonomy for the needs of model training through federated learning.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example Federated Learning Environment

FIG. 1 illustrates a federated learning environment 100, in accordance with various embodiments. The federated learning environment 100 includes an online system 110 including an aggregating device 120, a plurality of contributing devices 130 (individually referred to as “contributing device 130”), and a network 105. The online system 110 is connected to the contributing devices 130 through the network 105. In other embodiments, the federated learning environment 100 may include fewer, more, or different components. For example, the federated learning environment 100 may include more than one online system 110 or aggregating device 120. As another example, the federated learning environment 100 may include a different number of contributing devices 130. Functionality attributed to a component of the federated learning environment 100 may be accomplished by a different component included in the federated learning environment 100 or by a different device or system. For instance, functionality attributed to the aggregating device 120 may be accomplished by one or more contributing devices 130.

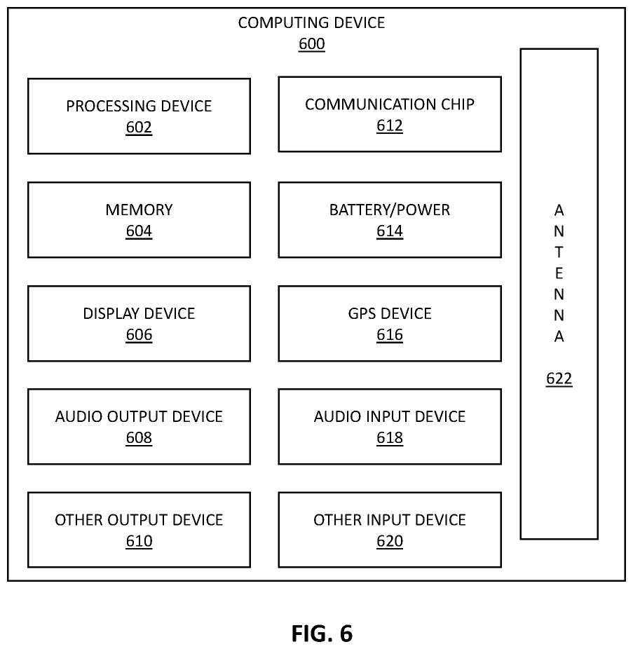

The online system 110 can provide or receive data from the contributing devices 130 through the network 105. The online system 110 may be a server, such as an edge cloud server. In some embodiments, the communication between the online system 110 and a contributing device 130 may be developed based on a request for connection from the contributing device 130. The online system 110 may determine whether to connect with the contributing device 130, e.g., based on information of the contributing device 130 or information of a user associated with the contributing device 130. In some embodiments, the online system 110 may include one or more computing systems. A computing system may include one or more processing devices (e.g., graphical processing unit (GPU), central processing unit (CPU), vision processing unit (VPU), neural processing unit (NPU), field programmable gate array (FPGA), etc.), one or more memories (e.g., static random-access memory (SRAM), dynamic random-access memory (SRAM), etc.), and so on. An example computing system is the computing device 600 in FIG. 6.

The aggregating device 120 in the online system 110 can facilitate training of machine learning models through federated learning, including federated learning adaptive to capabilities of the contributing devices 130. The aggregating device may maintain one or more model collections. A model collection may be specific to a particular type of task, e.g., image classification, navigation control, language processing, and so on. The model collection includes machine learning models that are generated for performing the type of task. In some embodiments, the machine learning modes in the same model collection may include the same algorithm. Different machine learning models in the same model collection may have different sizes, internal parameters, network architectures, other attributes, or some combination thereof.

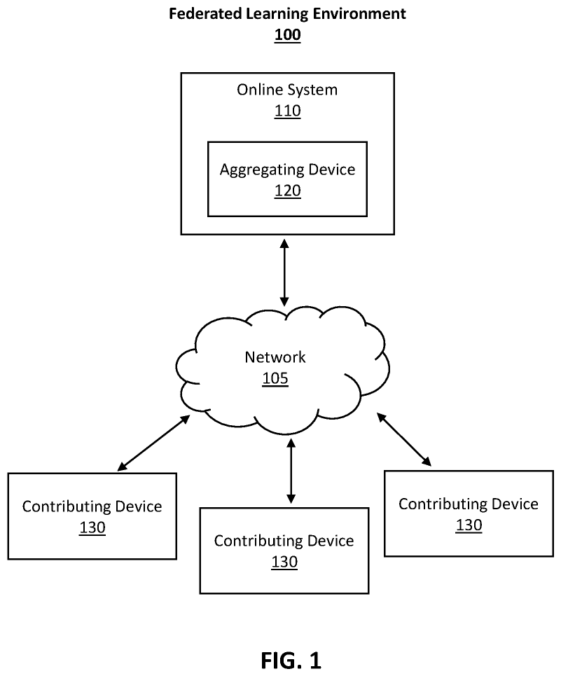

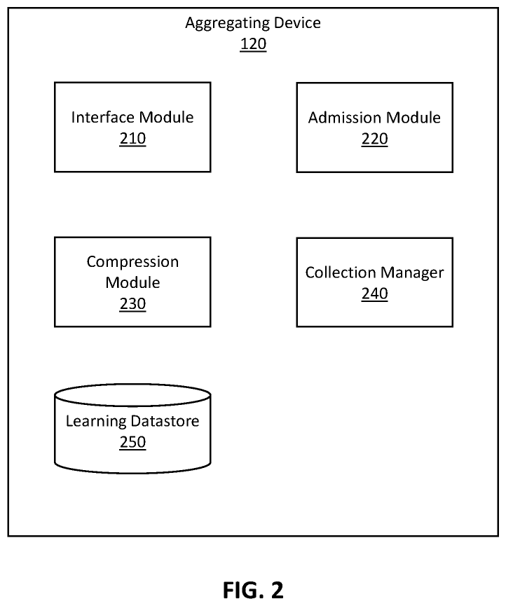

The aggregating device 120 may manage model collections. For instance, the aggregating device 120 may add one or more machine learning models into a model collection. A machine learning model may be provided by a contributing device 130. The aggregating device 120 may also facilitate training of machine learning models by the contributing devices 130 based on capabilities of the contributing devices 130. For instance, the aggregating device 120 may compress the model collection based on the capability of a particular contributing device 130. The aggregating device 120 may compress the same model collection differently for contributing devices 130 with different capabilities. A machine learning model may be updated (e.g., trained) by the contributing device 130 providing the model or one or more other contributing devices 130. Variations in the manners of how the contributing devices 130 generate or train machine learning models can lead to variations in the machine learning models in the same model collection. The aggregating device 120 may remove one or more machine learning models from a model collection, e.g., based on timestamps of the models or information of the models provided by contributing devices 130. In other embodiments, the aggregating device 120 may perform other types of actions to models in a model collection. Certain aspects of the aggregating device 120 are described below in conjunction with FIG. 2.

A contributing device 130 may be one or more computing devices capable of receiving or transmitting data via the network 105. For instance, the contributing device 130 may transmit capability status reports and learning status reports to the aggregating device 120 for federated learning. The contributing device 130 may also receive model collections (e.g., compressed model collections) from the aggregating device 120. A contributing device 130 may be capable of training models with machine learning techniques. In some embodiments, a contributing device 130 may use local data to train models. A contributing device 130 may also evaluate a model. For instance, the contributing device 130 may evaluate similarity of a model with one or more other models, evaluate accuracy of a model, and so on.

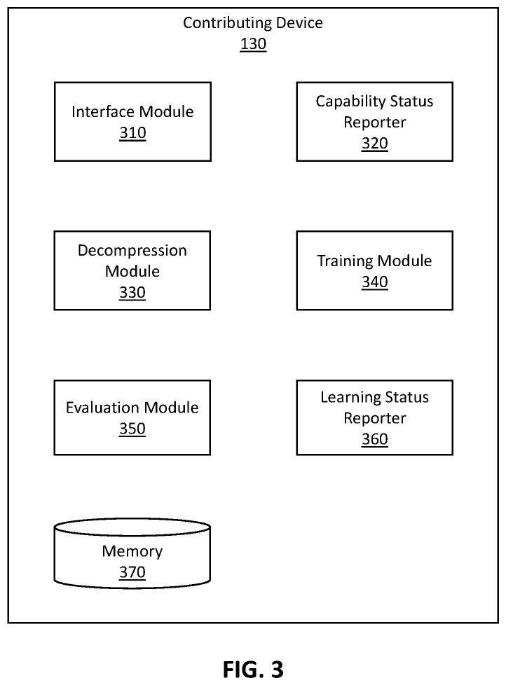

In some embodiments, a contributing device 130 includes a conventional computer system, such as a desktop or a laptop computer. Alternatively, a contributing device 130 may be a device having computer functionality, such as a personal digital assistant (PDA), a mobile telephone, a smartphone, a wearable device, a robot, an autonomous vehicle, another suitable device, or some combination thereof. In some embodiments, a contributing device 130 is an integrated computing device that operates as a standalone network-enabled device. For example, the contributing device 130 includes display, speakers, microphone, camera, and input device. In another embodiment, a contributing device 130 is a computing device for coupling to an external media device such as a television or other external display and/or audio output system. In this embodiment, the contributing device 130 may couple to the external media device via a wireless interface or wired interface (e.g., an HDMI (High-Definition Multimedia Interface) cable) and may utilize various functions of the external media device such as its display, speakers, microphone, camera, and input devices. Here, the contributing device 130 may be configured to be compatible with a generic external media device that does not have specialized software, firmware, or hardware specifically for interacting with the contributing device 130. Certain aspects of the contributing device 130 are described below in conjunction with FIG. 3.

The network 105 supports communications of the online system 110 with the contributing devices 130. The network 105 may comprise any combination of local area and/or wide area networks, using both wired and/or wireless communication systems. In one embodiment, the network 105 may use standard communications technologies and/or protocols. For example, the network 105 may include communication links using technologies such as Ethernet, 1010.11, worldwide interoperability for microwave access (WiMAX), 3G, 4G, code division multiple access (CDMA), digital subscriber line (DSL), etc. Examples of networking protocols used for communicating via the network 105 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 105 may be represented using any suitable format, such as hypertext markup language (HTML) or extensible markup language (XML). In some embodiments, all or some of the communication links of the network 105 may be encrypted using any suitable technique or techniques.

FIG. 2 is a block diagram of the aggregating device 120, in accordance with various embodiments. The aggregating device 120 includes an interface module 210, an admission module 220, a compression module 230, a collection manager 240, and a learning datastore 250. In other embodiments, the aggregating device 120 may include fewer, more, or different components. Functionality attributed to a component of the aggregating device 120 may be accomplished by a different component included in the aggregating device 120, a component included in the online system 110, or by a different device or system.

The interface module 210 facilitates communications of the aggregating device 120 with other devices or systems. In some embodiments, the interface module 310 establishes communications between the aggregating device 120 with contributing devices, such as the contributing devices 130. The interface module 310 may receive requests from contributing devices for engaging with the aggregating device 120, e.g., for federated learning. The interface module 310 may support the aggregating device 120 to distribute model collections to the contributing devices. The interface module 210 may also receive data, such as capability status reports and learning status reports, from the contributing devices. The interface module 210 may forward received data to one or more other components of the aggregating device 120. The interface module 210 may also send data generated by one or more other components of the aggregating device 120 to other devices or systems.

The admission module 220 admits contributing devices (e.g., the contributing devices) to be members of federated learning groups managed by the aggregating device 120. A federated learning group may be a group of contributing devices that can train one or more models to be used for a particular type of task. The admission module 220 may form or organize the federated learning group by admitting contributing devices into the federated learning group. The federated learning group may have a model collection that includes models generated for the type of task. The admission module 220 may receive a request (also referred to as “admission request”) for engaging with the aggregating device 120 for federated learning from a contributing device, e.g., through the interface module 210, and determine whether the contributing device can be paired with a model collection maintained by the aggregating device 120. A model collection maintained by the aggregating device 120 may be stored in the learning datastore 250. The admission module 220 may determine whether to admit a contributing device based on data in the admission request or the learning datastore 250.

In some embodiments, to determine whether the contributing device can be paired with a model collection, the admission module 220 may determine whether the contributing device can provide or train at least one machine learning model in a model collection maintained by the aggregating device 120. In an example where the admission request indicates a type of task for which the contributing device needs a machine learning model, the admission module 220 may determine whether the aggregating device 120 maintains a model collection for the type of task. In another example, the admission module 220 may determine whether the contributing device has access to data that can be used to train at least one machine learning model in a model collection maintained by the aggregating device 120. In yet another example, the admission module 220 may determine whether the request includes a model that can be added to a model collection maintained by the aggregating device 120.

After determining that the contributing device can provide or train at least one machine learning model in a model collection, the admission module 220 may admit the contributing device, e.g., as a member of a federated learning group associated with the model collection. In some embodiments, the admission module 220 may classify the contributing device based on a determination whether the request includes a model, such as a model generated or trained by the contributing device. In embodiments where the request includes a model, the admission module 220 may assign a privilege to the contributing device for providing the model. For instance, the admission module 220 may give the contributing device a higher priority for offloading workload to the contributing device. In embodiments where the request does not include a model, the admission module 220 may give the contributing device a regular priority for offloading workload. The admission module 220 may provide models in requests from contributing devices to the collection manager 240 for determining whether to add the model to the corresponding model collection(s).

The compression module 230 compresses model collections based on capabilities of contributing devices. In some embodiments, a contributing device admitted by the admission module 220 may provide a capability status report. The capability status report may be included in the admission request or be provided by the contributing device after the contributing device is admitted. In some embodiments, a capability status report may include information about resources available in the contributing devices for training one or more machine learning models, such as the current computing availability and energy autonomy of the contributing device. A capacity status report may include information describing one or more capabilities of the contributing device 130 that are related to training models. Examples of the capabilities include computational capabilities (such as available processing units, e.g., CPU, GPU, NPU, FPGA, etc.), hardware acceleration capabilities, memory capabilities (e.g., available memory resources, free storage size, bandwidth, etc.), energy capabilities (such as available energy resources, e.g., power grid, battery, etc.), connectivity capabilities (e.g., multi-Radio Access Network connection capability, network bandwidth, etc.), other capabilities related to training models, or some combination thereof.

The compression module 230 may determine whether to compress a model collection paired with a contributing device based on the capability status report from the contributing device. For instance, the compression module 230 may determine to compress the model collection based on a determination that the storage size of the model collection without compression is greater than the available memory capability or connectivity capability of the contributing device. In some embodiments, the compression module 230 may select a compression technique to compress model collection based on the capability status report from the contributing device. For instance, the compression module 230 may determine which compression technique can reduce the storage size of the model collection to a size that is proper considering the available memory capability or connectivity capability of the contributing device. The compression module 230 may receive different capability status reports from the same contributing device, e.g., in different rounds of the federated learning, as the resources available at the contributing device may vary in time. The compression module 230 may provide different compressed model collections to the contributing device.

To compress a model collection, the compression module 230 may encode the models in the model collection using fewer bits than the original representations of the models. The compression may be lossy or lossless. In some embodiments where the compression module 230 compresses a model collection, every model in the model collection may be compressed. Alternatively, the compression module 230 may select one or more models in the model collection and compress the selected model(s), while leaving one or more other models in the model collection uncompressed. The compression module 230 may transmit the compressed model collection to the contributing device, e.g., through the interface module 210.

A contributing device may provide multiple capacity status reports that may indicate different capabilities of the contributing device at different times. The compression module 230 may generate a compressed model collection every time a different capacity status report is received, despite that the compression module 230 has already generated one or more compressed model collections for the contributing device. In some embodiments, the compression module 230 may generate a first compressed model collection for a contributing device by decompressing a second compressed model collection. The second compressed model collection may be generated for the same contributing device or another contributing device, which had less available resources than the contributing device in the current round. The compression module 230 may decompress the second compressed model collection based on the capability status report of the contributing device in the current round or the capability status report used to generate the second compressed model collection. For instance, the compression module 230 may decompress the second compressed model collection based on a difference between the two capability status reports.

The collection manager 240 manages model collections. The collection manager 240 may manage model collections associated with various tasks, such as language processing, image classification, learning relationships between objects (e.g., people, biological cells, devices, etc.), control behaviors for devices (e.g., robots, machines, etc.), and so on. The collection manager 240 may group models to be used for the same type of task as a model collection. In some embodiments, the collection manager 240 groups models having the same algorithm as a model collection. The collection manager 240 may store model collections and information about the model collections in the learning datastore 250.

The collection manager 240 may modify model collections. In some embodiments, the collection manager 240 may add new machine learning models to model collections. For example, the collection manager 240 may receive a model from a contributing device that has requested to engage with the aggregating device 120 and may add the model to the model collection paired with the contributing device. As another example, the collection manager 240 may add an updated model from a contribution device 130 to a model collection, e.g., after the model collection has been provided to the contributing devices and the contributing devices have trained a model in the model collection.

In some embodiments, the collection manager 240 may remove models from model collections. For example, the collection manager 240 may identify one or more models in a model collection based on the timestamps of the models, e.g., timestamps indicating when the models were generated or updated. The collection manager 240 may remove one or more models associated with the earliest timestamp. The removal of a model may be triggered by the addition of a new model. For instance, the collection manager 240 may replace an existing model in a model collection with a new model received from a contributing device. The new model may be a model generated by the contributing device before the model collection is provided to the contributing device or may be generated by the contributing device through training a model in the model collection.

In some embodiments, the collection manager 240 may generate one or more new models for a model collection. The collection manager 240 may combine models from multiple contributing devices to generate a single model and add the single model to the model collection. For instance, the collection manager 240 may average the models trained by the contributing devices, e.g., by averaging internal parameters of the models, etc., to generate an average model and add the average model to the model collection. In some embodiments, the models from the contributing devices may be the best scoring models, such as models having the highest similarity score(s) or models having the lowest error score(s). A similarity score of a model may measure the degree of similarity between the model with one or more other models in the model collection. An error score of a model may indicate a likelihood of an output of the model being erroneous. In some embodiments, the collection manager 240 may receive identifying information of the models from the contributing devices. In an example, the identifying information of a model may be the index of the model in the model collection. The communication of the contributing devices with the aggregating device 120 may be of minimal payload. A few bits may be sufficient to represent the index of a model.

The collection manager 240 may reduce the size of a model collection to a predetermined size by removing models from the model collection. The size of the model collection may be measured by the number of models in the model collection. The collection manager 240 may receive information indicating evaluation of a model by a contributing device, such as information indicating that the model has worse performance than one or more other models in the model collection. For instance, the model may have lower similarity score or higher error score. The collection manager 240 may remove a model based on the evaluation information. In some embodiments, the collection manager 240 may count how many contributing devices have classified a model as a worse performing model. The collection manager 240 may remove the model that has the highest count.

In some embodiments, the collection manager 240 may keep removing models till a predetermined number of models are left. The predetermined size may be a predetermined number may be 1 or other numbers, such as other small numbers like 3, 5, 7, and so on. In some embodiments (such as embodiments where multiple models are left in the model collection after the removal is completed), the collection manager 240 may also average the models to produce a single model. The single model may be used by the contributing device or other devices or systems to perform the task.

The learning datastore 250 stores data associated with federated learning managed by the aggregating device 120. The learning datastore 250 may store data received, generated, used, or otherwise associated with the aggregating device 120. For instance, the learning datastore 250 may store model collections, including compressed model collections, decompressed model collections, and so on. The learning datastore 250 may also store information of models in the model collections, such as indexes of the models, timestamps indicating when the models are generated or updated, sources of the models, and so on. The learning datastore 250 may also store data from contributing devices, such as admission requests, similarity scores of models, error scores of models, and so on.

FIG. 3 is a block diagram of the contributing device 130, in accordance with various embodiments. The contributing device 130 includes an interface module 310, a capability status reporter 320, a decompression module 330, a training module 340, an evaluation module 350, a learning status reporter 360, and a memory 370. In other embodiments, the contributing device 130 may include fewer, more, or different components. Functionality attributed to a component of the contributing device 130 may be accomplished by a different component included in the contributing device 130 or by a different device or system. For instance, some or all functionality attributed to a component of the contributing device 130 may be accomplished by the aggregating device 120.

The interface module 310 facilitates communications of the contributing device 130 with other devices or systems. The interface module 310 may forward received data to one or more other components of the contributing device 130. The interface module 310 may also send data generated by one or more other components of the contributing device 130 to other devices or systems. In some embodiments, the interface module 310 establishes communications between the contributing device 130 with the aggregating device 120. The interface module 310 may send admission requests to the aggregating device 120, e.g., for joining a federated learning group managed by the aggregating device 120. The interface module 310 may support the contributing device 130 to receive one or more model collections from the aggregating device 120. The interface module 310 may also support the contributing device 130 to transmit data, such as capability status reports and learning status reports, to the aggregating device 120.

The capability status reporter 320 generates capacity status reports. As described above, a capacity status report may include information describing one or more capabilities of the contributing device 130 that are related to training models, such as computational capabilities (e.g., availability of CPU, GPU, NPU, FPGA, etc.), hardware acceleration capabilities, memory capabilities (e.g., memory size, bandwidth, etc.), energy capabilities (e.g., information indicating whether the contributing device is connected to the power grid or not, current expected battery lifetime, etc.), connectivity capabilities (e.g., multi-Radio Access Network connection capability, network bandwidth, etc.), other capabilities related to training models, or some combination thereof.

In some embodiments, the capability status reporter 320 may periodically check available resources in the contributing device 130 for training models. For instance, the capability status reporter 320 may detect whether there is any change in the available resources at a predetermined frequency. After a change in the available resources is detected, the capability status reporter 320 may generate a new capacity status report and provide the report to the aggregating device 120, e.g., through the interface module 310. Additionally or alternatively, the capability status reporter 320 may generate a new capability status report in response to the detection of a critical event. The critical event may be an event occurring at the contributing device 130 or the aggregating device 120 that is related to training models. Examples of the critical event may include the contributing device 130 sending an admission request to the aggregating device, the aggregating device 120 admitting the contributing device 130, the aggregating device 120 pairing the contributing device 130 with a model collection, the contributing device 130 finishing the execution of an application, the contributing device 130 finish training a model, and so on.

The decompression module 330 decompresses compressed model collection received from the aggregating device 120. The decompression module 330 may decompress a compressed model collection based on the compression technique used by the aggregating device 120 to generate the compressed model collection. In some embodiments, the decompression module 330 may decompress every model in the compressed model collection. In other embodiments, the decompression module 330 may select one or more models in the compressed model collection for decompression and leave one or more other models in the compressed model collection as is.

The training module 340 trains models in model collections received from the aggregating device 120 by using data available at the contributing device 130. The data may be collected by the contributing device 130. For example, the data may be data provided by a user of the contributing device 130 through one or more input devices associated with the contributing device 130. As another example, the contributing device 130 may collect the data using one or more sensors that can detect the environment of the contributing device. As yet another example, the contributing device 130 may receive the data from one or more other devices or systems. In some embodiments, the data may remain local to the contributing device 130. For instance, the data is not provided to the aggregating device 120 or another contributing device 130.

The training module 340 may form a training dataset with the data to train a model. The training module 340 may extract features from the training dataset. The features may be variables deemed potentially relevant to the task to be performed by the model. An ordered list of the features may be a feature vector. In some embodiments, the training module 340 may apply dimensionality reduction (e.g., via linear discriminant analysis (LDA), principal component analysis (PCA), or the like) to reduce the amount of data in the feature vectors to a smaller, more representative set of data. The training module 340 may use supervised machine learning to train the model. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

Taking deep neural networks (DNNs) for example, in an embodiment where the training module 340 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a evaluation subset used by the evaluation module 350 to validate performance of a model. The portion of the training dataset not including the tuning subset and the evaluation subset may be used to train the DNN.

The training module 340 may determine hyperparameters for training a DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 4, 40, 500, 400, or even larger.

The training module 340 may define the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different category by training.

In the process of defining the architecture of the DNN, the training module 340 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 340 defines the architecture of the DNN, the training module 340 inputs a training dataset into the DNN. The training dataset includes a plurality of training samples. An example of a training sample includes an object in an image and a ground-truth label of the object. The training module 340 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 340 uses a cost function to minimize the error.

The training module 340 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 340 finishes the predetermined number of epochs, the training module 340 may stop updating the parameters in the DNN. The DNN having the updated parameters is referred to as a trained DNN.

The evaluation module 350 evaluates models in model collections received from the aggregating device 120. In some embodiments, the evaluation module 350 may evaluate models in a model collection before the training module 340 trains any models in the model collection. Additionally or alternatively, the evaluation module 350 may evaluate models in a model collection after the training module 340 trains one or more models in the model collection. The evaluation module 350 may use one or more metrics to evaluate models.

In some embodiments, the evaluation module 350 may evaluate the similarity of a model with one or more other models. The evaluation module 350 may determine a similarity score for each model under evaluation. The similarity score of a model in a model collection may indicate how much the model is similar to one or more other models in the model collection. The model having a higher similarity score may be a model that is more similar to other models in the model collection and may be considered as having better performance. The evaluation module 350 may rank some or all models in the model collection based on the similarity scores of the models.

Additionally or alternatively, the evaluation module 350 may evaluate the accuracy or error rate of a model. The evaluation module 350 may determine an error score for each model under evaluation. The error score of a model in a model collection may indicate how many errors the model has made. The model having a higher error score may be a model that makes more errors and may be considered as having worse performance. The evaluation module 350 may rank some or all models in the model collection based on the error scores of the models.

In some embodiments, the evaluation module 350 may determine the error score of a model based on an evaluation of the accuracy of the model. The more accurate the model, the lower the error score is. Taking a DNN for example, the evaluation module 350 may input samples in a validation dataset into the DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the evaluation module 350 may determine an accuracy score measuring the precision, recall, or a combination of precision and recall of the DNN. The evaluation module 350 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The evaluation module 350 may compare the accuracy score with a threshold score. In an example where the evaluation module 350 determines that the accuracy score of the augmented model is less than the threshold score, the evaluation module 350 instructs the training module 340 to re-train the DNN. In one embodiment, the training module 340 may iteratively re-train the DNN until the occurrence of a stopping condition, such as the accuracy measurement indication that the DNN may be sufficiently accurate, or a number of training rounds having taken place.

In some embodiments (e.g., embodiments where the evaluation module 350 evaluates both similarity and error rate of a model), the evaluation module 350 may determine a performance score for the model by aggregating the similarity score and error score of the model. The performance score may be a sum, weighted sum, average, or weight average of the similarity score and error score. In some embodiments, the evaluation module 350 may classify models based on the similarity scores, error scores, or performance scores of the models. the models. For instance, the evaluation module 350 may classify the model(s) having the highest similarity score or lowest error score as the model(s) having the best performance in the model collection, versus classify the model(s) having the lowest similarity score or highest error score as the model(s) having the worst performance in the model collection.

The learning status reporter 360 generates learning status reports. A learning status report includes information indicating model training or evaluation by the contributing device 130. In an example, a learning status report may include a model trained by the contributing device 130. As another example, a learning status report may include information of a model trained or evaluated by the contributing device, such as the index of the model in the corresponding model collection, the similarity score of the model, the error score of the model, the performance of the model, other information of the model, or some combination thereof. A learning status report may include more than one model or information about more than one model. The learning status reporter 360 may generate a learning status report after the training or evaluation of one or more models is completed. In some embodiments, the learning status reporter 360 may generate a learning status report after a request for learning status report is received, e.g., from the aggregating device 120.

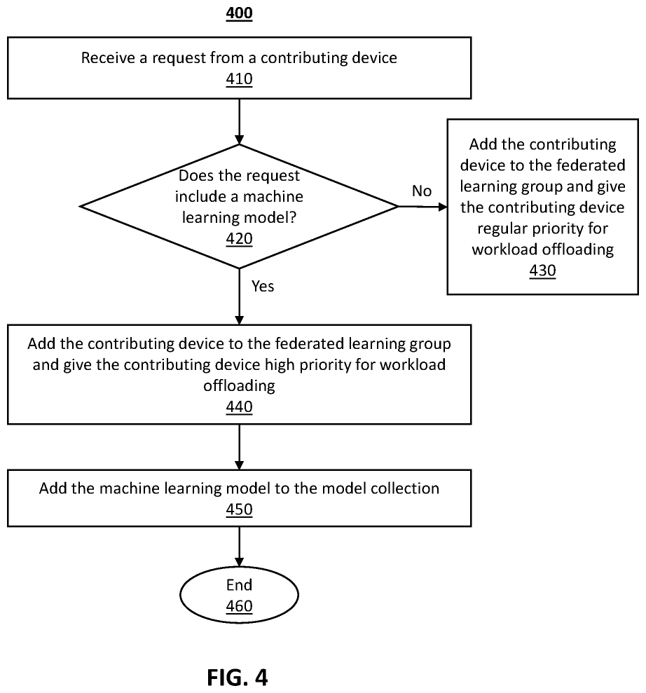

The memory 370 stores data received, generated, used, or otherwise associated with the contributing device 130. For example, the memory 370 stores the datasets used by the capability status reporter 320, decompression module 330, training module 340, evaluation module 350, or learning status reporter 360. The memory 370 may also store data generated by the capability status reporter 320, decompression module 330, training module 340, evaluation module 350, or learning status reporter 360. In the embodiment of FIG. 4, the memory 370 is a component of the contributing device 130. In other embodiments, the memory 370 may be external to the contributing device 130 and communicate with the contributing device 130 through a network.

### Example Processing of Admitting Contributing Devices

FIG. 4 illustrates a process 400 of an aggregating device admitting a new contributing device, in accordance with various embodiments. An embodiment of the aggregating device may be the aggregating device 120. An embodiment of the new contributing device may be the contributing device 130. The process 400 may be performed at least partially by the admission module 220 in FIG. 2. Although the process 400 is described with reference to the flowchart illustrated in FIG. 4, many other methods for an aggregating device to admit a new contributing device may alternatively be used. For example, the order of execution of the steps in FIG. 4 may be changed. As another example, some of the steps may be changed, eliminated, or combined.

In step 410, the aggregating device receives a request from the contributing device. The request may be a request to join a federated learning group managed by the aggregating device or a request for a model collection maintained by the aggregating device.

In step 420, the aggregating device determines whether the request includes a machine learning model. In embodiments where the answer is no, the process 400 goes to step 430, in which the aggregating device adds the contributing device to the federated learning group and gives the contributing device regular priority for workload offloading.

In embodiments where the answer is yes, the process 400 goes to step 440, in which the aggregating device adds the contributing device to the federated learning group and gives the contributing device high priority for workload offloading. Contributing devices, which have provided models to the aggregating device, can have higher priority for workload offloading than contributing devices that have not provided models to the aggregating device.

In step 450, the aggregating device adds the machine learning model to the model collection. In some embodiments, the aggregating device may replace an existing model with the machine learning model in the request. The replaced model may be an old model, e.g., a model that was generated or trained before one or more other models in the model collection. In step 460, the process 400 ends.

### Example Method of Federated Learning

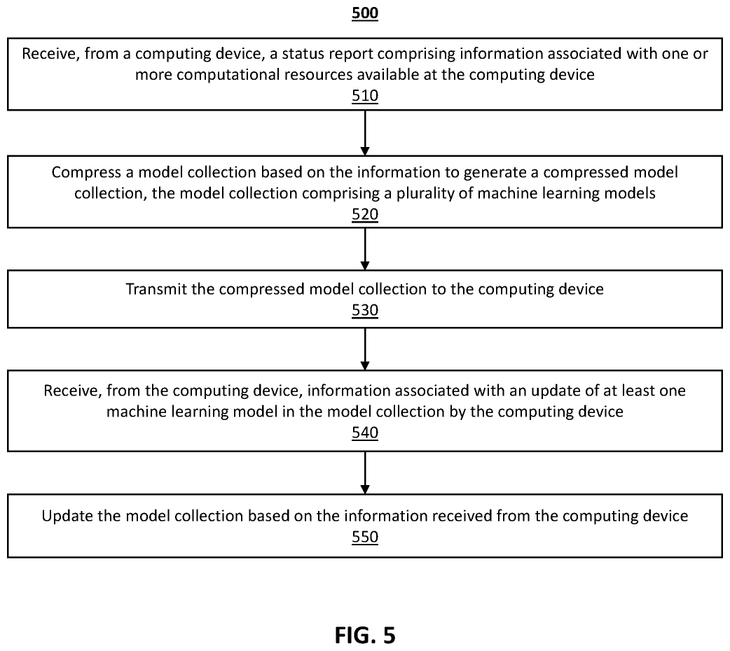

FIG. 5 is a flowchart showing a method 500 of federated learning, in accordance with various embodiments. The method 500 may be performed by the online system 110 in FIG. 1. Although the method 500 is described with reference to the flowchart illustrated in FIG. 5, many other methods for federated learning may alternatively be used. For example, the order of execution of the steps in FIG. 5 may be changed. As another example, some of the steps may be changed, eliminated, or combined.

The online system 110 receives 510 a status report from a computing device. In some embodiments, the computing device is a contributing device, such as the contributing device 130. The status report comprises information associated with one or more computational resources available at the computing device. In some embodiments, the status report indicates the capability of the computing device for training one or more machine learning models. For instance, the status report includes information about processing unit, memory, bandwidth, or other resources that are available at the computing device for training one or more machine learning models.

The online system 110 compresses 520 a model collection based on the information to generate a compressed model collection. The model collection comprises a plurality of machine learning models. In some embodiments, the online system 110 compresses the model collection based on available memory storage or bandwidth of the computing device.

In some embodiments, the online system 110 receives, from the computing device, a request for associating with the online system, the request comprising a machine learning model. The online system 110 generates the model collection by adding the machine learning model in the request to a previous model collection. In some embodiments, the previous model collection comprises a plurality of previous machine learning models. The online system 110 identifies a previous machine learning model in the previous model collection based on timestamps associated with the plurality of previous machine learning models. The online system 110 replaces the previous machine learning model with the machine learning model in the request.

The online system 110 transmits 530 the compressed model collection to the computing device. In some embodiments, every machine learning model in the model collection is compressed. The computing device, after receiving the compressed model collection, decompresses one or more compressed machine learning models in the compressed model collection.

The online system 110 receives 540, from the computing device, information associated with an update of at least one machine learning model in the model collection by the computing device. In some embodiments, the computing device updates a machine learning model by training the machine learning model using data available to the computing device. In some embodiments, the data used to train the machine learning model remains local and is not provided to the online system 110. In some embodiments, the computing device evaluates the updated machine learning model. In an example, the computing device determines a similarity score of the updated machine learning model. The similarity score indicates a similarity between the updated machine learning model and one or more other machine learning models in the model collection. In another example, the computing device determines an error score of the updated machine learning model. The error score indicates how likely the output of the update machine learning model would be erroneous.

The online system 110 updates 550 the model collection based on the information received from the computing device. In some embodiments, the online system 110 adds the machine learning model updated by the computing device to the model collection. In some embodiments, the online system 110 identifies another machine learning model in the model collection, e.g., based on a timestamp associated with the machine learning model. The online system replaces the identified machine learning model with the machine learning model updated by the computing device.

In some embodiments, the online system 110 is in communication with a group of computing devices that includes the computing device. The online system 110 receives, from the group of computing devices, information associated with a set of machine learning models. Each machine learning model in the set is included in the model collection or is generated by at least one computing device in the group. The online system 110 generates a new machine learning model based on the set of machine learning models and adds the new machine learning model to the model collection.

In some embodiments, a machine learning model in the set is selected by a computing device in the group based on a similarity score determined by the computing device in the group. The similarity score indicates a degree of similarity between the machine learning model in the set and one or more machine learning models in the model collection. In some embodiments, a machine learning model in the set is selected by a computing device in the group based on an evaluation of an accuracy of the machine learning model in the set. In some embodiments, the online system 110 identifies a machine learning model in the model collection based on a timestamp associated with the machine learning model and replaces the machine learning model with the new machine learning model.

In some embodiments, the online system 110 receives, from the group of computing devices, information associated with one or more machine learning models in the model collection. The one or more machine learning models have been classified by the group computing devices as having worse performance than one or more other machine learning models in the model collection. The online system 110 removes at least one of the one or more machine learning models from the model collection. In some embodiments, the online system 110 selects a machine learning model from the one or more machine learning models based on a number of computing devices in the group that has classified the machine learning model as having worse performance than the one or more other machine learning models in the model collection. The online system 110 removes the machine learning model from the model collection.

### Example Computing Device

FIG. 6 is a block diagram of an example computing device 600, in accordance with various embodiments. In some embodiments, the computing device 600 may be used for at least part of the aggregating device 120 or at least part of a contributing device 130 in FIG. 1. A number of components are illustrated in FIG. 6 as included in the computing device 600, but any one or more of these components may be omitted or duplicated, as suitable for the application. In some embodiments, some or all of the components included in the computing device 600 may be attached to one or more motherboards. In some embodiments, some or all of these components are fabricated onto a single system on a chip (SoC) die. Additionally, in various embodiments, the computing device 600 may not include one or more of the components illustrated in FIG. 6, but the computing device 600 may include interface circuitry for coupling to the one or more components. For example, the computing device 600 may not include a display device 606, but may include display device interface circuitry (e.g., a connector and driver circuitry) to which a display device 606 may be coupled. In another set of examples, the computing device 600 may not include an audio input device 618 or an audio output device 608, but may include audio input or output device interface circuitry (e.g., connectors and supporting circuitry) to which an audio input device 618 or audio output device 608 may be coupled.

The computing device 600 may include a processing device 602 (e.g., one or more processing devices). The processing device 602 processes electronic data from registers and/or memory to transform that electronic data into other electronic data that may be stored in registers and/or memory. The computing device 600 may include a memory 604, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 604 may include memory that shares a die with the processing device 602. In some embodiments, the memory 604 includes one or more non-transitory computer-readable media storing instructions executable for federated learning, e.g., the method 500 described above in conjunction with FIG. 5 or some operations performed by the aggregating device 120 or contributing device 130 in FIG. 1. The instructions stored in the one or more non-transitory computer-readable media may be executed by the processing device 602.

In some embodiments, the computing device 600 may include a communication chip 612 (e.g., one or more communication chips). For example, the communication chip 612 may be configured for managing wireless communications for the transfer of data to and from the computing device 600. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 612 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 612 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 612 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 612 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 612 may operate in accordance with other wireless protocols in other embodiments. The computing device 600 may include an antenna 622 to facilitate wireless communications and/or to receive other wireless communications (such as AM or FM radio transmissions).

In some embodiments, the communication chip 612 may manage wired communications, such as electrical, optical, or any other suitable communication protocols (e.g., the Ethernet). As noted above, the communication chip 612 may include multiple communication chips. For instance, a first communication chip 612 may be dedicated to shorter-range wireless communications such as Wi-Fi or Bluetooth, and a second communication chip 612 may be dedicated to longer-range wireless communications such as global positioning system (GPS), EDGE, GPRS, CDMA, WiMAX, LTE, EV-DO, or others. In some embodiments, a first communication chip 612 may be dedicated to wireless communications, and a second communication chip 612 may be dedicated to wired communications.

The computing device 600 may include battery/power circuitry 614. The battery/power circuitry 614 may include one or more energy storage devices (e.g., batteries or capacitors) and/or circuitry for coupling components of the computing device 600 to an energy source separate from the computing device 600 (e.g., AC line power).

The computing device 600 may include a display device 606 (or corresponding interface circuitry, as discussed above). The display device 606 may include any visual indicators, such as a heads-up display, a computer monitor, a projector, a touchscreen display, a liquid crystal display (LCD), a light-emitting diode display, or a flat panel display, for example.

The computing device 600 may include an audio output device 608 (or corresponding interface circuitry, as discussed above). The audio output device 608 may include any device that generates an audible indicator, such as speakers, headsets, or earbuds, for example.

The computing device 600 may include an audio input device 618 (or corresponding interface circuitry, as discussed above). The audio input device 618 may include any device that generates a signal representative of a sound, such as microphones, microphone arrays, or digital instruments (e.g., instruments having a musical instrument digital interface (MIDI) output).

The computing device 600 may include a GPS device 616 (or corresponding interface circuitry, as discussed above). The GPS device 616 may be in communication with a satellite-based system and may receive a location of the computing device 600, as known in the art.

The computing device 600 may include another output device 610 (or corresponding interface circuitry, as discussed above). Examples of the other output device 610 may include an audio codec, a video codec, a printer, a wired or wireless transmitter for providing information to other devices, or an additional storage device.

The computing device 600 may include another input device 620 (or corresponding interface circuitry, as discussed above). Examples of the other input device 620 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 600 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 600 may be any other electronic device that processes data.

### Selected Examples

The following paragraphs provide various examples of the embodiments disclosed herein.

Example 1 provides a computer-implemented method, including receiving, by an online system from a computing device, a status report including information associated with one or more computational resources available at the computing device; compressing, by the online system, a model collection based on the status report to generate a compressed model collection, the model collection including a plurality of machine learning models; transmitting, by the online system to the computing device, the compressed model collection; receiving, by the online system from the computing device, information associated with an update of at least one machine learning model in the model collection by the computing device; and updating, by the online system, the model collection based on the information received from the computing device.

Example 2 provides the computer-implemented method of example 1, where the online system is in communication with a group of computing devices that includes the computing device, and the method further includes receiving, by the online system from the group of computing devices, information associated with a set of machine learning models, where each machine learning model in the set is included in the model collection or is generated by at least one computing device in the group; generating a new machine learning model based on the set of machine learning models; and adding the new machine learning model to the model collection.

Example 3 provides the computer-implemented method of example 2, where a machine learning model in the set is selected by a computing device in the group based on a similarity score determined by the computing device in the group, the similarity score indicating a degree of similarity between the machine learning model in the set and one or more machine learning models in the model collection.

Example 4 provides the computer-implemented method of example 2 or 3, where a machine learning model in the set is selected by a computing device in the group based on an evaluation of an accuracy of the machine learning model in the set.

Example 5 provides the computer-implemented method of any one of examples example 2-4, where adding the new machine learning model to the model collection includes identifying a machine learning model in the model collection based on a timestamp associated with the machine learning model; and replacing the machine learning model with the new machine learning model.

Example 6 provides the computer-implemented method of any of the preceding examples, where the online system is in communication with a group of computing devices that includes the computing device, and the method further includes receiving, by the online system from the group of computing devices, information associated with one or more machine learning models in the model collection, where the one or more machine learning models have been classified by the group computing devices as having worse performance than one or more other machine learning models in the model collection; and removing at least one of the one or more machine learning models from the model collection.

Example 7 provides the computer-implemented method of example 6, where removing at least one of the one or more machine learning models from the model collection includes selecting a machine learning model from the one or more machine learning models based on a number of computing devices in the group that has classified the machine learning model as having worse performance than the one or more other machine learning models in the model collection; and removing the machine learning model from the model collection.

Example 8 provides the computer-implemented method of any of the preceding examples, further including receiving, from the computing device, a request for associating with the online system, the request including a machine learning model; and generating the model collection by adding the machine learning model in the request to a previous model collection.

Example 9 provides the computer-implemented method of example 8, where the previous model collection includes a plurality of previous machine learning models, and generating the model collection includes identifying a previous machine learning model in the previous model collection based on timestamps associated with the plurality of previous machine learning models; and replacing the previous machine learning model with the machine learning model in the request.

Example 10 provides the computer-implemented method of any of the preceding examples, where the plurality of machine learning models in the model collection is generated for performing a same machine learning task.

Example 11 provides one or more non-transitory computer-readable media storing instructions executable to perform operations, the operations including receiving, by an online system from a computing device, a status report including information associated with one or more computational resources available at the computing device; compressing, by the online system, a model collection based on the status report to generate a compressed model collection, the model collection including a plurality of machine learning models; transmitting, by the online system to the computing device, the compressed model collection; receiving, by the online system from the computing device, information associated with an update of at least one machine learning model in the model collection by the computing device; and updating, by the online system, the model collection based on the information received from the computing device.

Example 12 provides the one or more non-transitory computer-readable media of example 11, where the online system is in communication with a group of computing devices that includes the computing device, and the operations further include receiving, by the online system from the group of computing devices, information associated with a set of machine learning models, where each machine learning model in the set is included in the model collection or is generated by at least one computing device in the group; generating a new machine learning model based on the set of machine learning models; and adding the new machine learning model to the model collection.

Example 13 provides the one or more non-transitory computer-readable media of example 11 or 12, where the online system is in communication with a group of computing devices that includes the computing device, and the operations further include receiving, by the online system from the group of computing devices, information associated with one or more machine learning models in the model collection, where the one or more machine learning models have been classified by the group computing devices as having worse performance than one or more other machine learning models in the model collection; and removing at least one of the one or more machine learning models from the model collection.

Example 14 provides the one or more non-transitory computer-readable media of any one of examples 11-13, where the operations further include receiving, from the computing device, a request for associating with the online system, the request including a machine learning model; and generating the model collection by adding the machine learning model in the request to a previous model collection.

Example 15 provides the one or more non-transitory computer-readable media of any one of examples 11-14, where the plurality of machine learning models in the model collection is generated for performing a same machine learning task.

Example 16 provides an apparatus, including a computer processor for executing computer program instructions; and a non-transitory computer-readable memory storing computer program instructions executable by the computer processor to perform operations including receiving, by an online system from a computing device, a status report including information associated with one or more computational resources available at the computing device, compressing, by the online system, a model collection based on the status report to generate a compressed model collection, the model collection including a plurality of machine learning models, transmitting, by the online system to the computing device, the compressed model collection, receiving, by the online system from the computing device, information associated with an update of at least one machine learning model in the model collection by the computing device, and updating, by the online system, the model collection based on the information received from the computing device.

Example 17 provides the apparatus of example 16, where the online system is in communication with a group of computing devices that includes the computing device, and the operations further include receiving, by the online system from the group of computing devices, information associated with a set of machine learning models, where each machine learning model in the set is included in the model collection or is generated by at least one computing device in the group; generating a new machine learning model based on the set of machine learning models; and adding the new machine learning model to the model collection.

Example 18 provides the apparatus of example 16 or 17, where the online system is in communication with a group of computing devices that includes the computing device, and the operations further include receiving, by the online system from the group of computing devices, information associated with one or more machine learning models in the model collection, where the one or more machine learning models have been classified by the group computing devices as having worse performance than one or more other machine learning models in the model collection; and removing at least one of the one or more machine learning models from the model collection.

Example 19 provides the apparatus of any one of examples 16-18, where the operations further include receiving, from the computing device, a request for associating with the online system, the request including a machine learning model; and generating the model collection by adding the machine learning model in the request to a previous model collection.

Example 20 provides the apparatus of examples 16-19, where the plurality of machine learning models in the model collection is generated for performing a same machine learning task.

Example 21 provides a computer-implemented method, including generating, by a computing device, a first status report including information associated with one or more computational resources available at the computing device; transmitting, by the computing device to an online system, the first status report; receiving, by the computing device from the online system, a compressed model collection, the compressed model collection generated by compressing a model collection, which includes a plurality of machine learning models, based on the first status report; updating, by the computing device, a machine learning model in the model collection; generating, by the computing device, a second status report including information associated with the machine learning model in the model collection; and transmitting, by the computing device to an online system, the second status report.

Example 22 provides the computer-implemented method of example 21, where updating the machine learning model in the model collection includes training the machine learning model by using data available at the computing device.

Example 23 provides the computer-implemented method of example 21 or 22, further including evaluating, by the computing device, performances of the plurality of machine learning models; identifying, by the computing device, one or more machine learning models from the plurality of machine learning models based on the performances; and including, by the computing device, information associated with the one or more machine learning models in the second status report.

Example 24 provides the computer-implemented method of example 23, where evaluating performances of the plurality of machine learning models includes for each respective machine learning model, determining a similarity score of the respective machine learning model, the similarity score indicating a degree of similarity between the respective machine learning model and one or more other machine learning models in the model collection.

Example 25 provides the computer-implemented method of example 23 or 24, where evaluating performances of the plurality of machine learning models includes for each respective machine learning model, determining an accuracy of the respective machine learning model.

Example 26 provides one or more non-transitory computer-readable media storing instructions executable to perform the method of any one of examples 21-25.

Example 27 provides an apparatus, including a computer processor for executing computer program instructions; and a non-transitory computer-readable memory storing computer program instructions executable to perform the method of any one of examples 21-25.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method, comprising:
receiving, by an online system from a computing device, a status report comprising information associated with one or more computational resources available at the computing device;
compressing, by the online system, a model collection based on the status report to generate a compressed model collection, the model collection comprising a plurality of machine learning models;
transmitting, by the online system to the computing device, the compressed model collection;
receiving, by the online system from the computing device, information associated with an update of at least one machine learning model in the model collection by the computing device; and
updating, by the online system, the model collection based on the information received from the computing device.

2. The computer-implemented method of claim 1, wherein the online system is in communication with a group of computing devices that includes the computing device, and the method further comprises:
receiving, by the online system from the group of computing devices, information associated with a set of machine learning models, wherein each machine learning model in the set is included in the model collection or is generated by at least one computing device in the group;
generating a new machine learning model based on the set of machine learning models; and
adding the new machine learning model to the model collection.

3. The computer-implemented method of claim 2, wherein a machine learning model in the set is selected by a computing device in the group based on a similarity score determined by the computing device in the group, the similarity score indicating a degree of similarity between the machine learning model in the set and one or more machine learning models in the model collection.

4. The computer-implemented method of claim 2, wherein a machine learning model in the set is selected by a computing device in the group based on an evaluation of an accuracy of the machine learning model in the set.

5. The computer-implemented method of claim 2, wherein adding the new machine learning model to the model collection comprises:
identifying a machine learning model in the model collection based on a timestamp associated with the machine learning model; and
replacing the machine learning model with the new machine learning model.

6. The computer-implemented method of claim 1, wherein the online system is in communication with a group of computing devices that includes the computing device, and the method further comprises:
receiving, by the online system from the group of computing devices, information associated with one or more machine learning models in the model collection, wherein the one or more machine learning models have been classified by the group computing devices as having worse performance than one or more other machine learning models in the model collection; and
removing at least one of the one or more machine learning models from the model collection.

7. The computer-implemented method of claim 6, wherein removing at least one of the one or more machine learning models from the model collection comprises:
selecting a machine learning model from the one or more machine learning models based on a number of computing devices in the group that has classified the machine learning model as having worse performance than the one or more other machine learning models in the model collection; and
removing the machine learning model from the model collection.

8. The computer-implemented method of claim 1, further comprising:
receiving, from the computing device, a request for associating with the online system, the request comprising a machine learning model; and
generating the model collection by adding the machine learning model in the request to a previous model collection.

9. The computer-implemented method of claim 8, wherein the previous model collection comprises a plurality of previous machine learning models, and generating the model collection comprises:
identifying a previous machine learning model in the previous model collection based on timestamps associated with the plurality of previous machine learning models; and
replacing the previous machine learning model with the machine learning model in the request.

10. The computer-implemented method of claim 1, wherein the plurality of machine learning models in the model collection is generated for performing a same machine learning task.

11. One or more non-transitory computer-readable media storing instructions executable to perform operations, the operations comprising:
receiving, by an online system from a computing device, a status report comprising information associated with one or more computational resources available at the computing device;
compressing, by the online system, a model collection based on the status report to generate a compressed model collection, the model collection comprising a plurality of machine learning models;
transmitting, by the online system to the computing device, the compressed model collection;
receiving, by the online system from the computing device, information associated with an update of at least one machine learning model in the model collection by the computing device; and
updating, by the online system, the model collection based on the information received from the computing device.

12. The one or more non-transitory computer-readable media of claim 11, wherein the online system is in communication with a group of computing devices that includes the computing device, and the operations further comprise:
receiving, by the online system from the group of computing devices, information associated with a set of machine learning models, wherein each machine learning model in the set is included in the model collection or is generated by at least one computing device in the group;
generating a new machine learning model based on the set of machine learning models; and
adding the new machine learning model to the model collection.

13. The one or more non-transitory computer-readable media of claim 11, wherein the online system is in communication with a group of computing devices that includes the computing device, and the operations further comprise:
receiving, by the online system from the group of computing devices, information associated with one or more machine learning models in the model collection, wherein the one or more machine learning models have been classified by the group computing devices as having worse performance than one or more other machine learning models in the model collection; and
removing at least one of the one or more machine learning models from the model collection.

14. The one or more non-transitory computer-readable media of claim 11, wherein the operations further comprise:
receiving, from the computing device, a request for associating with the online system, the request comprising a machine learning model; and
generating the model collection by adding the machine learning model in the request to a previous model collection.

15. The one or more non-transitory computer-readable media of claim 11, wherein the plurality of machine learning models in the model collection is generated for performing a same machine learning task.

16. An apparatus, comprising:
a computer processor for executing computer program instructions; and
a non-transitory computer-readable memory storing computer program instructions executable by the computer processor to perform operations comprising:
receiving, by an online system from a computing device, a status report comprising information associated with one or more computational resources available at the computing device,
compressing, by the online system, a model collection based on the status report to generate a compressed model collection, the model collection comprising a plurality of machine learning models,
transmitting, by the online system to the computing device, the compressed model collection,
receiving, by the online system from the computing device, information associated with an update of at least one machine learning model in the model collection by the computing device, and
updating, by the online system, the model collection based on the information received from the computing device.

17. The apparatus of claim 16, wherein the online system is in communication with a group of computing devices that includes the computing device, and the operations further comprise:
receiving, by the online system from the group of computing devices, information associated with a set of machine learning models, wherein each machine learning model in the set is included in the model collection or is generated by at least one computing device in the group;
generating a new machine learning model based on the set of machine learning models; and
adding the new machine learning model to the model collection.

18. The apparatus of claim 16, wherein the online system is in communication with a group of computing devices that includes the computing device, and the operations further comprise:
receiving, by the online system from the group of computing devices, information associated with one or more machine learning models in the model collection, wherein the one or more machine learning models have been classified by the group computing devices as having worse performance than one or more other machine learning models in the model collection; and
removing at least one of the one or more machine learning models from the model collection.

19. The apparatus of claim 16, wherein the operations further comprise:
receiving, from the computing device, a request for associating with the online system, the request comprising a machine learning model; and
generating the model collection by adding the machine learning model in the request to a previous model collection.

20. The apparatus of claim 16, wherein the plurality of machine learning models in the model collection is generated for performing a same machine learning task.

21. An apparatus, comprising:
a computer processor for executing computer program instructions; and
a non-transitory computer-readable memory storing computer program instructions executable by the computer processor to perform operations comprising:
generating, by a computing device, a first status report comprising information associated with one or more computational resources available at the computing device,
transmitting, by the computing device to an online system, the first status report,
receiving, by the computing device from the online system, a compressed model collection, the compressed model collection generated by compressing a model collection, which comprises a plurality of machine learning models, based on the first status report,
updating, by the computing device, a machine learning model in the model collection,
generating, by the computing device, a second status report comprising information associated with the machine learning model in the model collection, and
transmitting, by the computing device to an online system, the second status report.

22. The apparatus of claim 21, wherein updating the machine learning model in the model collection comprises:
training the machine learning model by using data available at the computing device.

23. The apparatus of claim 21, wherein the operations further comprise:
evaluating, by the computing device, performances of the plurality of machine learning models;
identifying, by the computing device, one or more machine learning models from the plurality of machine learning models based on the performances; and
including, by the computing device, information associated with the one or more machine learning models in the second status report.

24. The apparatus of claim 23, wherein evaluating performances of the plurality of machine learning models comprises:
for each respective machine learning model, determining a similarity score of the respective machine learning model, the similarity score indicating a degree of similarity between the respective machine learning model and one or more other machine learning models in the model collection.

25. The apparatus of claim 23, wherein evaluating performances of the plurality of machine learning models comprises:
for each respective machine learning model, determining an accuracy of the respective machine learning model.
